(19) United States
(12) Patent Application Publication
(10) Pub. No.: US 2011/0288903 A1
(43) Pub. Date: Nov. 24, 2011

(54) METHOD OF OPTIMIZING THE MANAGEMENT OF WASTE RESULTING FROM A PROGRAM OF DRAINING AND DISMANTLING A FACILITY, ESPECIALLY A NUCLEAR FACILITY

(75) Inventors: Carole Mahe-Doutreluingne, Saint Marcel D'ardeche (FR); Stephane Robic, Villeneuve Les Avignon (FR); Patrick Devaux, Courthezon (FR)

(73) Assignee: COMMISSARIAT A L'ENERGIE ATOMIQUE ET AUX ENERGIES, Paris (FR)

(21) Appl. No.: 13/121,739

(22) PCT Filed: Sep. 28, 2009
(86) PCT No.: PCT/EP2009/062555

§ 371 Date: Jul. 26, 2011

(30) Foreign Application Priority Data
Sep. 30, 2008 (FR) 0805368

(51) Int. Cl. G06Q 10/00

(52) U.S. Cl. 705/7.23

(57) ABSTRACT

A method includes a first phase of characterizing waste of a plant and a second phase of selecting at least one system for treatment and determination of associated predicted streams of waste. The first phase includes a step of physical characterization and radiological characterization of each area, a step of physical characterization and radiological characterization of all the items of equipment present in the areas as a function of the step of characterization of the areas, and a step of compiling the physical and radiological characteristics of the items of equipment in which a description of a waste item to be produced is associated with the physical and radiological characteristics of each item of equipment. The second phase makes the selection of at least one system for the treatment and the determination of the associated predicted streams as a function of the descriptions of the waste to be produced and of the physical and radiological characteristics of the areas.

The present invention relates to a method for optimizing the management of waste originating from the program for draining and dismantling a plant, for example a nuclear plant. In what follows, in order to simplify the description, a nuclear plant is considered as a nonlimiting example.

The field of the invention is that of dismantling plants according to the following major phases notably:

operation;

definitive cessation of operation;

definitive shutdown;

possible waiting or supervision;

dismantling;

declassification;

possible demolition.

One of the major problems of draining/dismantling plants relates to the management of the waste. Several levels of different problems can arise, the four main ones of which are explained below.

On the safety level: it is necessary to optimize the management of the waste in order to be able to clear the latter away as quickly as possible. This optimization will make it possible to obtain a plant which, as soon as possible, presents only limited risks of contamination or irradiation.

On the technical level: it is necessary to optimize the management of the waste in order to be able to provide the facilities that may be necessary, such as notably the buffer zones, and new waste treatment plants, in order to clear away all the waste and make dismantling possible.

On the organization and dismantling time period level: it is necessary to optimize the management of the waste in order to make the production of the waste compatible with the various requirements relating to the elimination of this waste.

Finally, on the cost level: it is necessary to optimize the management of the waste in order to choose the systems most suitable for the waste, notably by assigning a value to or optimizing the category of waste by sorting at the source or by specific methods.

In the nuclear industry, the various problems mentioned above make it necessary to ensure, for many years, the traceability of the important data of a nuclear plant and to ensure that they are reliable.

A main difficulty is notably to be able to correctly and durably manage a large amount of data. Specifically, the data are very dispersed and spread because they involve many fields of competence differing greatly from one another and are established over very long periods, for example over several decades.

One object of the invention is notably to allow the centralization and ordering of the data concerned in order to make them usable, in particular to prevent the risks of losing information or of propagating errors.

Accordingly, the subject of the invention is a method as described by the claims.

Other features and advantages of the invention will become apparent with the aid of the following description made with respect to appended drawings which represent:

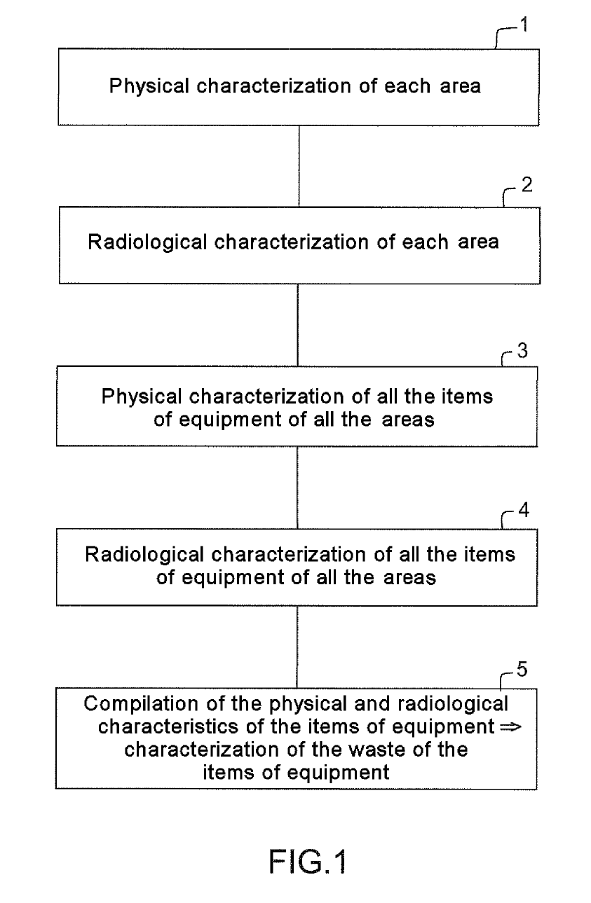

FIG. 1, an illustration of possible steps making up a first phase of the method according to the invention leading to the characterization of predicted waste;

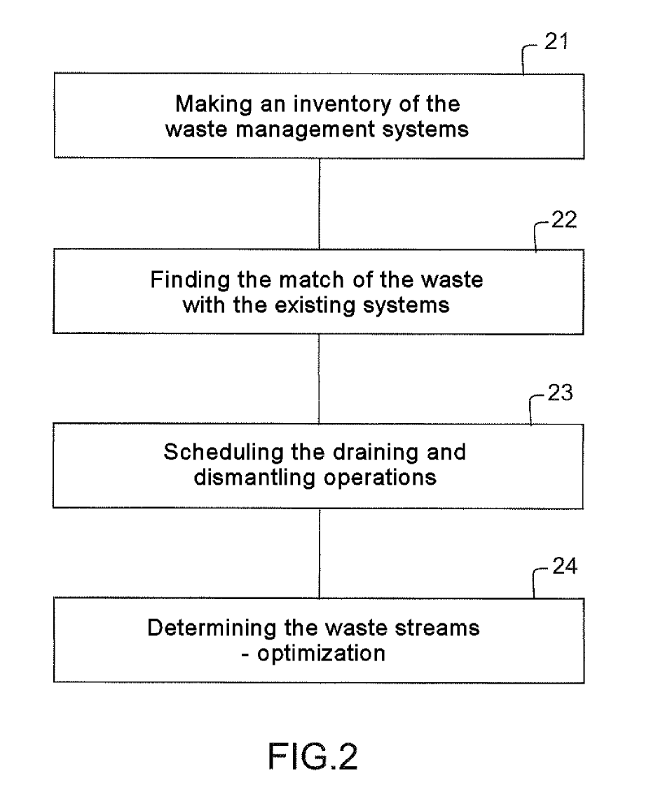

FIG. 2, an illustration of possible steps making up a second phase of the method according to the invention leading to the optimization of the management of the waste.

FIG. 1 illustrates the first phase of the method according to the invention applied to the draining and dismantling of a nuclear plant. This phase leads to the characterization of predicted waste specific to the plant to be drained and dismantled.

A nuclear plant comprises a set of areas in which elements or items of equipment that are more or less radioactive are located. The first phase of the method according to the invention makes it possible to characterize in the best possible way the nuclear waste to be produced. This characterization phase comprises, for example, five steps.

In a first step 1, a physical characterization is made of each area of the plant. This characterization can be achieved by a physical inventory of the physical characteristics of each area. These characteristics are for example as follows:
type of area;
identification of the area, notably by a reference;
designation of the area, corresponding notably to its destination or its function;
zoning of the waste of the area, that is to say its distribution by zones;
zoning of the radiation protection of the area;
geographic location of the area, defined notably by the level or floor on which the area is situated;
date of creation of the area;
shape of the area and its dimensions;
generic information on the area, indicating notably the types of coatings on the walls, on the floor and on the ceiling;
means of access to the area and dimensions of these access means;
fluids or gases available in the area;
remote operation means and their operating state;
available viewing means;
handling means;
ventilation present;
comprehensive list of items of equipment present in the area, indicating notably their designation, and their family and subfamily.

In a second step 2, the radiological characterization of each area of the plant is carried out. This characterization can be carried out by a radiological inventory of the physical characteristics of each area. These characteristics are for example as follows:
definition and location of the alpha contamination and of the beta gamma contamination present in the area in Bq/cm²;
definition and location of the hot points present in the area, given as a value of the maximum dose rate in contact and at 1 m in Sv/h;
definition of the ambient dose rate, given in Sv/h;
references of the radiological spectra, expressed through a list of the radioelements and their contribution to the radioactivity in percentage of overall radioactivity;
reference of the typical spectra with their reference dates;
identification of the activated items of equipment;
identification of retention of nuclear material.

All these data, collected in the first and the second step, are for example stored in a database. Knowing the physical characterization and the radiological characterization of each area makes it possible to optimize the physical, radiological and waste parameters of all the items of equipment present in each area.

Based on the physical and radiological parameters of each area obtained in the above two steps, the following steps 3, 4 carry out a physical and radiological characterization at the level of each item of equipment of each area of the plant.

In the third step 3, the physical characterization is then made of all the items of equipment present in all the areas of the plant. This characterization can be made by a comprehensive inventory of the physical parameters associated with each item of equipment. The required level of detail is indeed that of an item of equipment in order to be able to optimize the management of the waste in the end.

In order to describe all the physical parameters specific to each item of equipment, the data to be provided are for example as follows:
designation of the item of equipment;
the family it belongs to, as an example the item of equipment may belong to the pipes family or the ducts family;
its function;
its operational reference, a code for example;
its dimensions;
its weight;
the volume of space it requires;
its surface area;
its physical shape;
its chemical composition;
its associated waste zoning;
the degree to which it is sealed against contamination.

In the fourth step 4, the radiological characterization of all the items of equipment present in all the areas of the plant is carried out. This characterization can be done via a comprehensive inventory of the radiological parameters associated with each item of equipment. The required level of detail is again that of an item of equipment in order to be able to optimize the management of the waste in the end. In order to describe all the radiological parameters specific to each item of equipment, the data to be provided are for example as follows:
definition and location of the alpha contamination and of the beta gamma contamination present in the item of equipment in Bq/cm²;
definition and location of the hot points present in the item of equipment, given as a value of the maximum dose rate in contact and at 1 m in Sv/h;
definition of the ambient dose rate, given in Sv/h;
references of the radiological spectra, expressed through a list of the radioelements and their contribution to the radioactivity in percentage of overall radioactivity at the level of the item of equipment;
reference of the typical spectra with their reference dates;
identification of retention of nuclear material, in particular radioelement, weight of material, physical shape of the material, location of the material in the item of equipment.

The data listed in the third step 3 and the fourth step 4 are for example stored in the database.

In the fifth step 5, a compilation of the physical and radiological characterizations of the items of equipment is made, in particular a compilation of the physical and radiological data obtained in the two steps 3, 4 above for the purpose of characterizing the waste to be produced. In particular, a description of the waste to be produced is associated with the physical and radiological characteristics of each item of equipment.

The characteristics of the future waste relating to an item of equipment is deduced partly from the data obtained in these steps 3, 4. The characteristics to be obtained for an item of equipment are for example as follows:
volume of the waste;
weight of the waste;
rate of bulking of the waste;
classification of the waste according to the criteria: very low activity, low activity, medium activity, high activity;
designation of the waste;
category of the waste: nuclear or conventional;
activity by weight, in Bq/g, of the alpha and beta gamma emitters;
activity by weight, in Bq/g, of the alpha emitter of a period shorter than 31 years.

In order to optimize the management of the waste, it is possible to give a more comprehensive characterization of the waste, by indicating notably the list of the various components constituting an item of equipment, in particular the nature of the various materials and their proportion in weight and in volume.

FIG. 2 illustrates the second phase of the method according to the invention in which the treatment of the waste streams is estimated as a function of their characterization made in the first phase. The second phase comprises for example four steps.

In a first step 21, the waste management systems are listed, nuclear and conventional, existing or being created, and their characteristics. These systems may or may not be on the same site as the plant. The characteristics of a system notably involve the following parameters:
collection packages, upstream of transport to its treatment plant;
transport of the collection packages;
treatment plant;
final package produced by the treatment plant;
transport of the final package;
interim storage plant;
final storage plant.

With respect to the collection packages, they are characterized by physical criteria, their authorized physical-chemical natures, restricted or prohibited, their radiological criteria and their handling costs. The physical criteria relate notably to the type of container, the dimensions and the weight of the container, the maximum weight of the waste, the material of which the container is made, and the handling means.

With respect to a treatment plant, its characteristics are notably:
the nature of the treatment carried out;
the authorized physical-chemical natures, restricted or prohibited;
the authorized physical shapes, restricted or prohibited;
the maximum weight of a package, combining the container and the waste;
the maximum authorized radioactivity, by weight or total;
the authorized radioelements, restricted or prohibited;
the maximum dose rate on contact of a package;
the maximum labile and/or fixed contamination of the package;
the maximum weight of fissile material;
the treatment capacity of the plant;
the upstream interim storage capacity;
the downstream interim storage capacity;
the availability of the treatment plant.

The characteristics of a final package produced by a treatment plant are notably:
the physical characteristics such as the type of package, the dimensions, volumes and weights;
the radiological characteristics such as the maximum alpha and beta gamma activity, the maximum weight of fissile material, and the maximum dose rates on contact and at one meter.

Cost criteria may be added to these characteristics.

The characteristics of transporting a final package are notably the reference of a pack, the number of packages per transport pack, the transport approvals and authorizations and the number of packs available per year.

Finally, the characteristics of an interim storage plant and of a final storage plant are notably the reference of the plant, its handling capacity, its availability and its waste handling costs.

In a second step 22, a match is sought between each waste item to be produced and the systems inventoried in the previous step 21. In other words, the compatibility of the waste is checked, as characterized after the first phase with the systems that exist or are being created, defined in the first step 21 of the second phase. The comprehensiveness of the information requested in the first steps makes it possible to find the best system through a technical matching. If several systems can be envisaged, the aspects of cost, size and durability of the systems are used to make the best choice of system.

In the next step 23, the draining and dismantling operations are scheduled as a function of the results of the preceding steps. It is therefore possible to estimate the duration of the work, at the level of an area and of the complete plant. This scheduling of the work notably makes it possible to schedule the future waste clearances.

In the next step 24, all of the parameters for all the areas of the plant are optimized:
by an optimization of the waste streams and a matching of the streams relative to the treatment capacities, buffer or non-buffer interim storage requirements, in particular;
by an optimization of the treatment and of the associated costs through an appropriate classification of the waste categories.

Accordingly, the waste streams are determined according to the various categories of waste for each area. Then, by totaling all the waste of all the areas, all of the waste streams are estimated. It is then possible to verify the possibility of clearing them away while seeking the optimum or the best compromise between the costs and the duration of treatment of these streams. The optimal waste management system can be chosen from a list established in the database as a function of all of the parameters taken into account in the various characterization steps and as a function of the expressed constraints, such as for example the safety or cost conditions.

In parallel, it is possible to identify the waste that has no system, corresponding to none of the adopted systems, in order to determine the associated predicted streams. The waste with no system thus identified is taken into account in the risk analysis associated with the project and in the dimensioning of future plants.

1. A method for optimizing the management of waste originating from a program for draining and dismantling a plant including of a set of areas, said method comprising:
a first phase of characterizing the waste of said plant; and
a second phase of selecting at least one system for the treatment and determination of the associated predicted streams of waste, said first phase comprising:
a step of physical characterization and radiological characterization of each area;
a step of physical characterization and radiological characterization of all the items of equipment present in the areas as a function of the step of characterization of the areas;
a step of compiling the physical and radiological characteristics of the items of equipment in which a description of a waste item to be produced is associated with the physical and radiological characteristics of each item of equipment; wherein
the second phase further comprises making the selection of at least one system for the treatment and the determination of the associated predicted streams as a function of the descriptions of the waste to be produced and of the physical and radiological characteristics of the areas.

2. The method as claimed in claim 1, wherein the second phase further comprises a first step making an inventory of the waste management systems that are operational or being created.

3. The method as claimed in claim 2, herein the second phase further comprises a second step of finding the match of the waste with the systems.

4. The method as claimed in claim 3, wherein the second phase further comprises a step of scheduling the draining and dismantling operations as a function of the results of the preceding steps.

5. The method as claimed in claim 2, wherein the selection of the at least one system and the determination of the associated predicted streams is carried out as a function of the results of the preceding steps.

6. The method as claimed in claim 5, wherein a waste item to be produced is associated with a waste management system.

7. The method as claimed in claim 5, wherein the waste with no system is identified.

8. The method as claimed in claim 5, wherein the plant is a nuclear plant.
